(19) United States
(12) Patent Application Publication
(10) Pub. No.: US 2006/0172583 A1
(43) Pub. Date: Aug. 3, 2006

(54) Securing electrical receptacle with alternate on/off positions

(76) Inventor: Jerry R. Duhe JR., Houston, TX (US)

Correspondence Address: JERRY R. DUHE JR., P.O. BOX 670115, HOUSTON, TX, 77267, US

(21) Appl. No.: 11/331,563

(22) Filed: Jan. 14, 2006

Related U.S. Application Data
(60) Provisional application No. 60/644,457, filed on Jan. 15, 2005.

(51) Int. Cl. H01R 13/627; H01R 13/625; H01R 13/44

(52) U.S. Cl. 439/359; 439/345; 439/140

(57) ABSTRACT

A Securing electrical receptacle is provided, having plug receptors movably fastened within the chambers of the body capable of securing the power blades of an inserted male connector while allowing inward or outward movement to selected on or off positions, the receptacle further utilizes blade slot blocking members to obstruct foreign object insertion when improperly initiated without the male connector. The on and off availability is afforded by selection members disposed within the chambers providing a positive positioning in a sequential manner while inward and outward movement is directed by spring members adjacent each plug receptor in each chamber, a completed circuit is accomplished when the conductive contacts disposed within the body communicate with the conductive contacts within the plug receptors at the on position, simultaneously initiating the securing means thereto respectfully engage the power blades of the inserted male connector, similarly the ground receiving members are positioned within the plug receptors there to receive an inserted ground pin and communicate during and after relocation with grounding means to complete a grounded circuit, Foreign object obstruction is provided by blocking members that do not impede insertion, but are activated only when power is available and adapted to cover the blade entry slots having access to the contact members when initiated without male connector insertion and further to bind in a resilient manner against the power blades of the inserted male connector ready to cover the blade entry slots in the case of a forced male connector removal.

### BACKGROUND OF THE INVENTION

1. Field of the Invention

The present invention relates in general to electrical receptacles and more particular to securing or locking electrical receptacles with on and off capabilities not requiring rotation or and actuator.

2. Description of Prior Art

Possible electrical shock or physical damage to small children is always a prevalent thought in the minds of most parents and other concerned persons. In addition through our own experiences most of us have found that we too are not exempt from these unexpected accidental electrical mishaps. Many a person has received minor and even life threatening damage by merely inserting an electrical plug into a receptacle while accidentally touching one of both prongs. Continually powered outlets pose the danger of electrical shock by this accidental contact with the blades of the plug during insertion.

According to the US Consumer Product Safety Commission there are approximately 4,000 injuries (with some deaths) in the United States per year caused by electrical receptacles, the No. 1 cause of shock among small children is the insertion of metal keys into the electrical receptacle. The remaining numbers are divided into many categories, one of these such categories are injuries sustained from merely brushing up against an electrical receptacle resulting in shock or burn, this damage is caused by arc fault. This Arc Fault can be clearly seen when one plugs any device into a live electrical receptacle, upon insertion one will be able to witness the spark as the current is completed. With that, among the many fires that are caused by electrical receptacles each year in throughout the US, the No. 1 cause is arc fault, which is an unstable current surge in the electric lead lines causing a spike. These spikes are known to complete the circuit by connecting the two power blade slots of the receptacle by way of arc while the receptacle is not in use. This poses a fire danger especially when flammable objects are found next to the receptacles in question. Surge protectors address this issue in order to protect our expensive electronics by regulating the electrical current with intent to avoid possible spikes by terminating the power at a predefined level.

Along with that is the aggravation concerning power cords that are inadvertently displace from the outlet at what is seemingly the wrong time. With conventional outlets this could not be helped unless special attention were taken to ensure that no undue force were imposed upon the connection.

The most common household outlet has a pair of terminal contacts that receives the blade type terminal and are biased into contact with the blade terminal. The biasing force of the terminal contacts against the terminal blades is relatively light and the plug is easily inserted or removed from the outlet. The low pull force creates inconvenience where an inadvertent tug on an extension cord will pull the plug from the outlet. U.L. (Underwriters Laboratory) has specifications and definitions for each of the electrical receptacle that we enjoy every day. As there are many various receptacles available for each application, whether residential or the many levels of commercial and industrial including GFCI, U.L has set forth specification and definitions concerning the level of pull strength that it takes to remove the inserted male connector. In addition all other electrical product organizations such as NEMA (National Electric Manufactures Association) and NEC (National Electric code), all adopt

U.L regulations in the fabrication and distribution of such products. It has always been a goal of electrical product designers to make the outlet as safe as humanly possible within the scope of manufacture since the very first concept.

A number of the patents are directed at providing a safer outlet and locking the male connector securely while making power unavailable while not in use, one of these would be U.S. Pat. No. 5,286,213 this device offers such features, one being that it locks the male plug in securely, however not requiring a full insertion to provide power to partially inserted blades thereby creating a possible shock hazard. Furthermore if this design were fully turned to an on position without a male connector inserted it would render it as vulnerable as a typical outlet. However when not activated and used according to it's designers intention, the product would provide some level of safety concerning arc fault. This design, as with the others to follow requiring rotation of any kind would also require a substantial learning curve to operate, as well requiring face plate modifications if utilized as a wall receptacle. No. 5,286,213 as with the others to follow do not take into consideration various U.L (Underwriters Laboratory) safety specifications stating that a plug has a minimum and a maximum pull strength in order to remove the male connector without any activation other than pulling on the cord itself. All these such products would have to meet stringent regulation in order to approved and endorsed by such organizations as NESA, NEC, NEMA, USCPA, for commercial and residential use.

Another such design would be U.S. Pat. Nos. 5,393,239, 5,129,836, 5,413,498 all three of these designs would positively lock the male connector in place, but would not however allow for a forcible removal without damaging the female receptacle or the power cord that is attached. These designs afford no safety against shock on insertion or a remedy for arc fault, Nos. 5,393,239, 5,129,836 and 5,413,498 all would also require an actuation button to engage and disengage a male connector whether used on a wall receptacle or extension cord.

U.S. Pat. No. 4,846,707 employs an actuator arm that's operated with a heavy spring, this would of course make it hard for small children to operate, but it would be just as difficult for some of the elderly, not to mention it could require two hands in order to accomplish a successful insertion. As mentioned before U.L. (Underwriters Laboratory) has set forth definitions and specifications for many scenarios. For devices that employ actuators the concern is fatigue through multiple uses. These such rules and regulations would make it difficult if not impossible for this design to make it to the market and still be effective as it were originally intended. This design as with others would not offer any safety if the device were activated without a plug insertion, but only offers safety prior to insertion. No. 4,846,707 would also not address the problem with arc fault, because power would be available before the power blades of the male plug ever touched the contacts. And as with the above designs, U.L. specifications would not have been taken into effect concerning the poundage at witch the device would release the inserted plug without activation.

Another rotable design would be U.S. Pat. No. 6,079,995 this design incorporates a secure locking mechanism and the availability of power at will for the user. No. 6,079,995 as the others require rotation in one or more directions to accomplish the needed movement to afford the various levels of claimed safety. As mentioned before, all the rotable designs must require face plate modification in either industrial, commercial or residential use. And as mentioned earlier the learning curve in order to utilize these devices to their full potential could be enormous. With that said even though many of the rotable devices do accomplish the much need and wanted safety they are not available for sale in many if not all areas because of their lack of popularity and marketability.

### SUMMARY OF THE INVENTION

There is therefore a need to provide a securing electrical receptacle utilizing such features such as securing the male connector according to U.L. specifications, reducing if not eliminating arc fault and providing a safer outlet for small children to be around regardless of how the receptacle is used. While eliminating the need for end user modification and lessoning the inevitable learning curve so as to create a safer environment for the user and the non-user alike in the homes, and the workplace, thereby lessening the risk arc fault and of possible minor or life threatening shock.

The principle object of the present invention is to provide a securing electrical receptacle employing such safety features so as to considerably lessen the possibility of accidental shock to both children and adults.

It is also an object of the invention to give full control to the user whether he or she desires the electrical receptacle to have live current available at a specific time.

Another object of the invention is to provide a secure and constant connection between the electrically operated device and the electrical receptacle when live current is made available to lessen the possibility of unwanted accidental plug removal with intent to meet U.L. (Underwriters Laboratory) specifications and standards.

A further object of the present invention is for live current to only be available when initiated properly and completely by an electrical plug of an electrically operated device, and, when not in use to be considered harmless to playing children.

Another object of the present invention is to provide a means of blocking foreign object insertion when initiated improperly or if a male connector we forcibly remove from the outlet there by creating a safer environment for playing children.

A further object of the present invention is to be designed and constructed in such a way to make an easy if not foreseeable transition thereby limiting the operational learning curve. And further by utilizing specific materials for the purpose of economical manufacture and assembly so as to easily replace conventional means adjoining electrically operated devices, appliances, tools or machinery to an electrical power source regardless of the voltage or amperage requirements or plug prong configuration without major modifications as the spirit of the invention is set forth.

The foregoing objects, as well as other objects, which will become apparent from the discussion that follows are achieved according to the present new invention described herein as a SECURRING ELECTRICAL RECEPTACLE WITH ALTERNATE ON/OFF POSITIONS in which one embodiment comprises a rigid plastic or the like nonconductive body having a cover member/or ground strap for attachment to stud in wall or a switch box designed for concealment of such. The receptacle would further incorporate conductive members utilizing connecting screws to connect the electrical service to empower the receptacle. The front of the receptacle makes available plug receptors, which are attached within the body allowing for inward and outward movement to position the inserted electrical plug to either the on or off position.

When empowerment is desired an electrical plug with or without ground must be inserted fully and completely into a plug receptor pushed in slightly and released, at this point the receptor moves out slightly securing the inserted male connector by means of securing contact members not allowing for plug removal until unitiated. When this process has been initiated without proper male connector insertion the blocking members utilize an additional feature by positioning themselves within the power blade slot openings of the plug receptors, not allowing entry to foreign objects in order to prevent possible accidental shock or accessibility to small children. As the male connector and receptor reach the on position and are released, the plug receptor will spring outward slightly to a locked position completing contact with the conductive members thereby closing the circuit and making live current available. When plug removal is desired this process must be reversed. Immediately following the initiation of the reversal process, by pushing the receptor in slightly while holding on the inserted male connector, contact between conductive members will be broken, thereby opening the circuit and terminating the availability of live current. As the reversal process continues and the receptors inward movement terminates simultaneously the male connector is released by the locking members allowing removal. During retraction of the male connector the receptor moves out slightly in the same direction locating the receptor in the off position until further initiation.

### BRIEF DESCRIPTION OF THE DRAWINGS

FIG. 1. Is an exploded perspective view of the present invention revealing general assembly members.

FIG. 1a. Is a fragmentary view of a displaced positioning member with it's components.

FIG. 1b. Is a perspective view revealing the lower portions of a typical receptor.

FIG. 2. Is a fragmentary side view of a displaced positioning member with it's components.

FIG. 2a. Is a fragmentary side view of a displaced positioning member with it's components revealing progressional movement.

FIG. 2b. Is a fragmentary cross sectional side view of a instruction member with it's components within the instruction member.

FIG. 2c. Is a fragmentary side view of a displaced positioning member with it's components.

FIG. 3. is an exploded perspective view of the instruction member.

FIG. 3a. is an topical view of the instruction member revealing components.

FIG. 4. Is a perspective view revealing the lower portions and adjoining members of a typical receptor.

FIG. 4a. Is a perspective view revealing the lower portions and adjoining members of a typical receptor showing variation.

FIG. 4b. Is a perspective view revealing the lower portions and adjoining members of a typical receptor showing variation.

FIG. 5. is an exploded fragmentary view of assembly and components of a typical positioning member.

FIG. 5a. is an exploded fragmentary view of some components of a typical positioning member.

FIG. 5b. is an exploded fragmentary view of a portion of components and relation to assembly of a typical positioning member.

FIG. 6. Is a cross sectional view of a receptor and its communicable components.

FIG. 6a. Is a cross sectional view of a receptor and its communicable components.

FIG. 6b. Is a topical view of the body of the present invention revealing blocking member progression.

FIG. 7. Is a cross sectional view of a receptor and its communicable components.

FIG. 7a. Is a cross sectional view of a receptor and its communicable components.

FIG. 7b. Is a topical view of the body of the present invention revealing blocking member progression.

FIG. 8. Is a cross sectional view of a receptor and its communicable components.

FIG. 8a. Is a cross sectional view of a receptor and its communicable components.

FIG. 8b. Is a topical view of the body of the present invention revealing blocking member progression.

FIG. 9. Is an exploded perspective view of the instruction member in relation to the blocking member.

FIG. 10. Is a frontal view of a typical receptor.

FIG. 10a. Is a topical view of the cover member.

FIG. 10b. Is a cross sectional view of the present invention revealing member cooperation.

FIG. 10c. Is a topical view of the body revealing interior members and placement.

FIG. 11. Is a frontal view of a typical receptor.

FIG. 11a. Is a topical view of the cover member.

FIG. 11b. Is a side view of the conductive contacts and the ground strap.

FIG. 11c. Is a cross sectional view of the present invention revealing member cooperation.

FIG. 12. Is a cross sectional side view of the receptacle body in relation to the cover member and the receptors.

FIG. 12a. Is a cross sectional side view of the receptacle body in relation to the cover member and the ground strap.

FIG. 12b. Is a cross sectional side view of the receptacle body in relation to the cover member and the ground strap.

FIG. 13. Is an exploded cross sectional view of a receptor and its communicable components revealing progression thereof.

FIG. 13a. Is an exploded cross sectional view of a receptor and its communicable components revealing progression.

FIG. 13b. Is an enlarged topical view of the receptor and a cross sectional side view of the receptacle body in relation to the cover member and the ground strap.

FIG. 13c. Is a cross sectional side view of the receptacle body in relation to the cover member.

FIG. 14. Is cross sectional view of a securing means and conductive contacts.

FIG. 14a. Is cross sectional view of a securing means and conductive contacts.

FIG. 14b. Is cross sectional view of a conductive contact revealing slight variation in securing means cooperation.

FIG. 14c. Is a rear face transparent view of the conductive contact showing various placement.

FIG. 14d. Is a perspective view of the conductive contact.

FIG. 14e. Is a side view of the conductive contact in relation to the instruction member.

FIG. 14f. Is cross sectional view of a conductive contact showing securing means placement in progression.

FIG. 14g. Is cross sectional view of a conductive contact showing securing means placement in progression.

FIG. 14h. Is cross sectional view of a conductive contact showing securing means placement in progression.

FIG. 15. Is a frontal view of the present invention in the form of a surge protection/power strip device.

FIG. 15a. Is a perspective view of a retro fit receptacle.

FIG. 15b. Is the present invention utilized on a power cord.

FIG. 16. Is an exploded view of the present invention revealing components.

FIG. 16a. Is a fragmentary view of a portion of the positioning member in cooperation with shaft.

FIG. 16b. Is a perspective exploded view of a typical receptor showing placement of positioning member.

FIG. 17. Is a fragmentary view of a portion of the positioning member in cooperation with shaft.

FIG. 17a. Is a fragmentary view of the positioning member in cooperation with shaft and containing spring.

FIG. 17b. Is a fragmentary side view of the positioning member with cooperating members.

FIG. 17c. Is a fragmentary side view of a receptor with cooperating member placement.

FIG. 17d. Is a topical view of the blocking member.

FIG. 18. Is an exploded perspective view of the present invention revealing component placement with ground strap on front.

FIG. 18a. Is a perspective exploded view of a typical receptor showing placement of selection member and internal ground cooperative.

FIG. 19. Is a perspective exploded cut away view of a typical receptor showing placement of positioning member and blocking.

FIG. 19a. Is a perspective exploded cut away view of a typical receptor showing placement of positioning member and securing contact.

FIG. 19b. is an enlarged side view of a power blade of a male connector.

### DETAILED DESCRIPTION OF THE INVENTION

The present new invention consist of a combination and arrangement of parts herein-after more fully described and illustrated in the accompanying drawings, and more particularly pointed out in the appended claims, it being understood that changes may be made in form, size, proportions reversal of actions and minor details of construction without departing from the spirit or sacrificing any of the advantages of the invention.

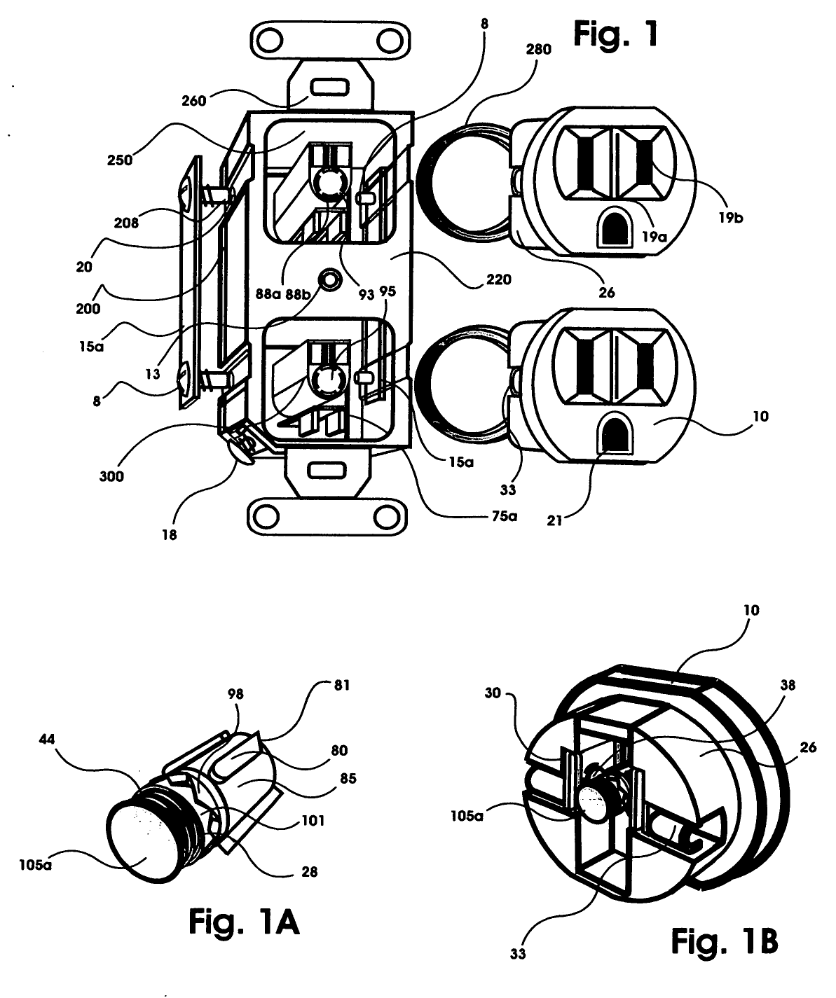

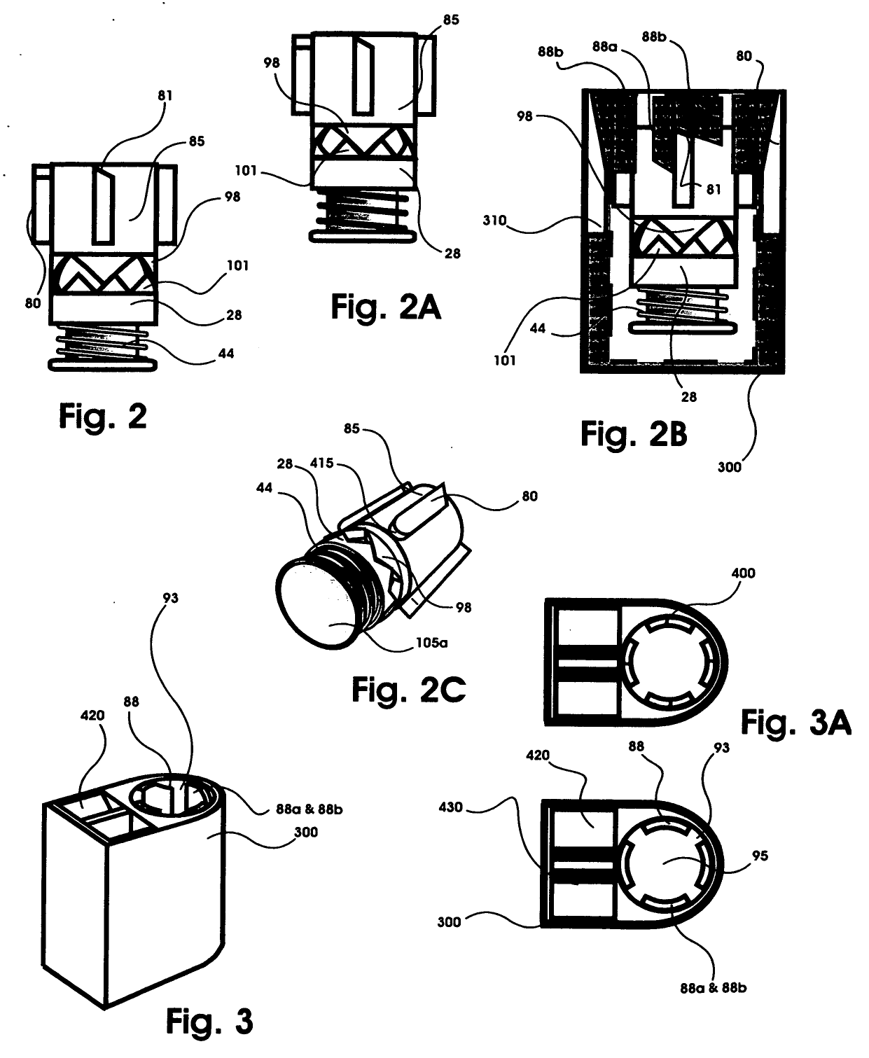

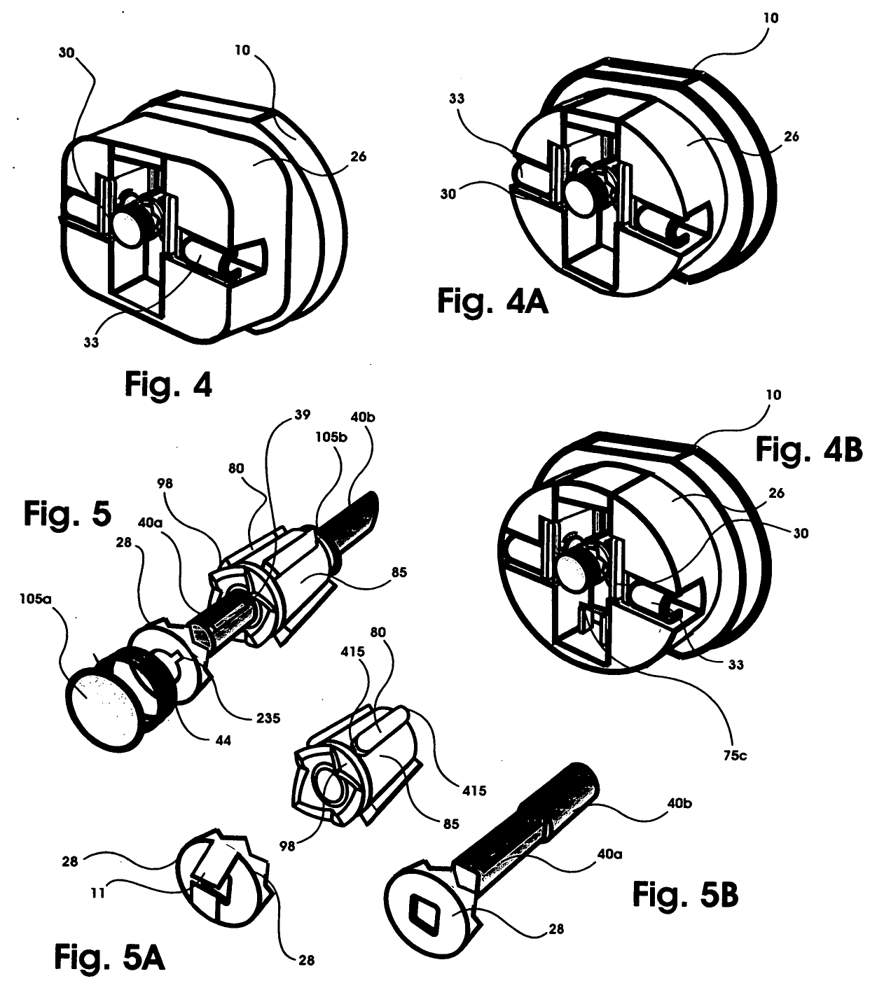

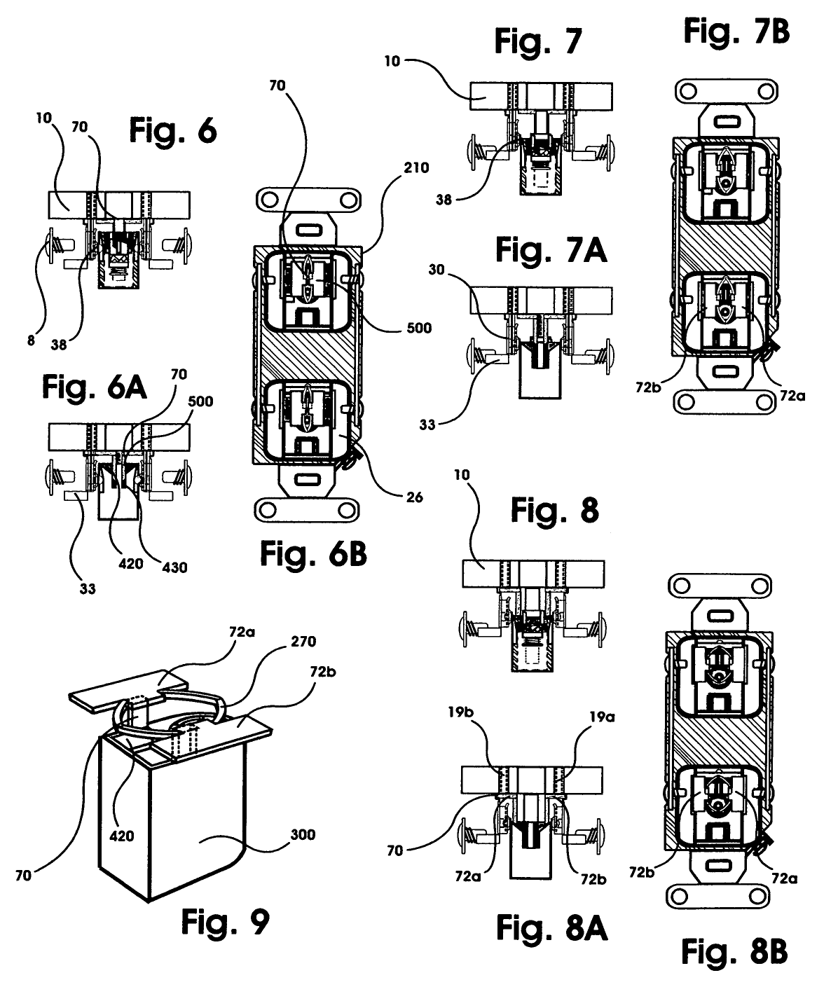

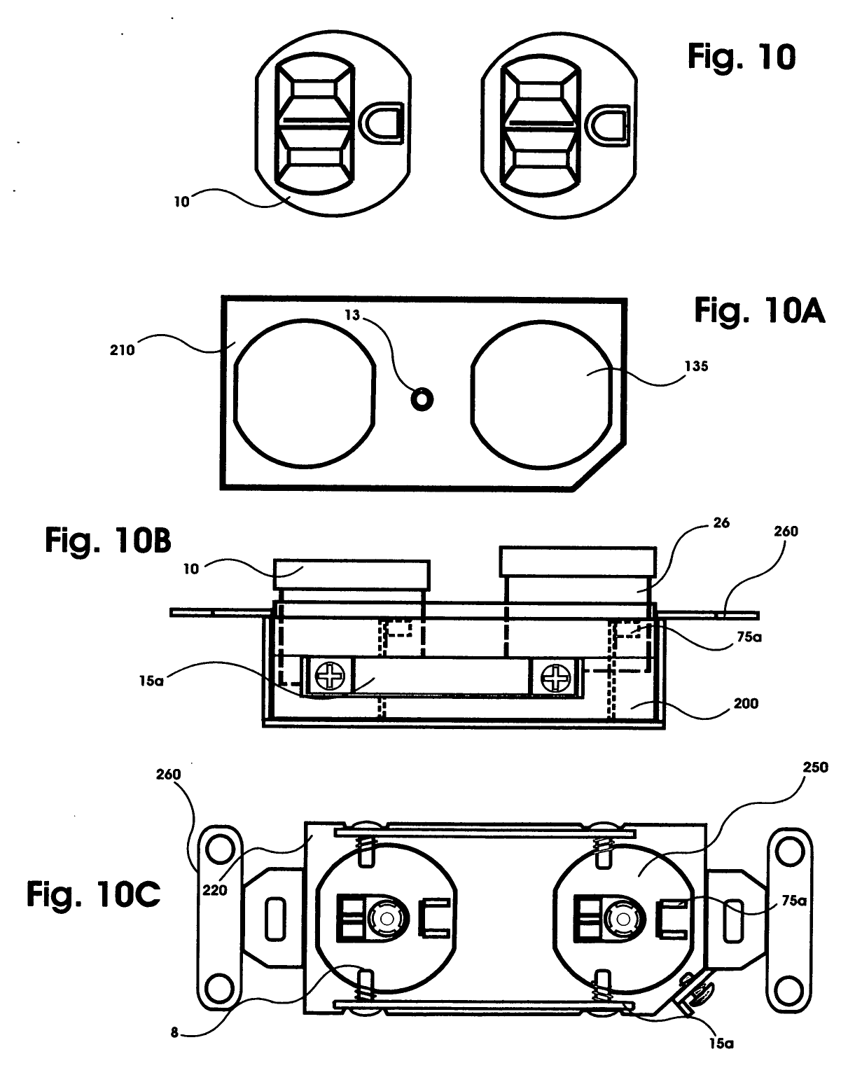

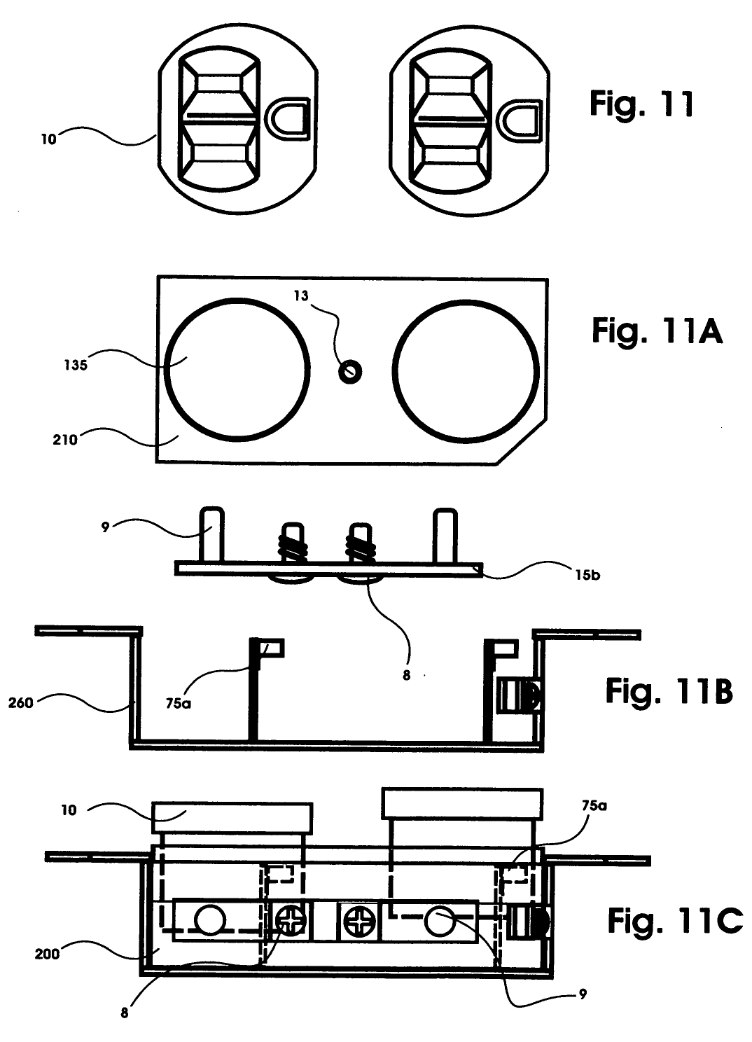

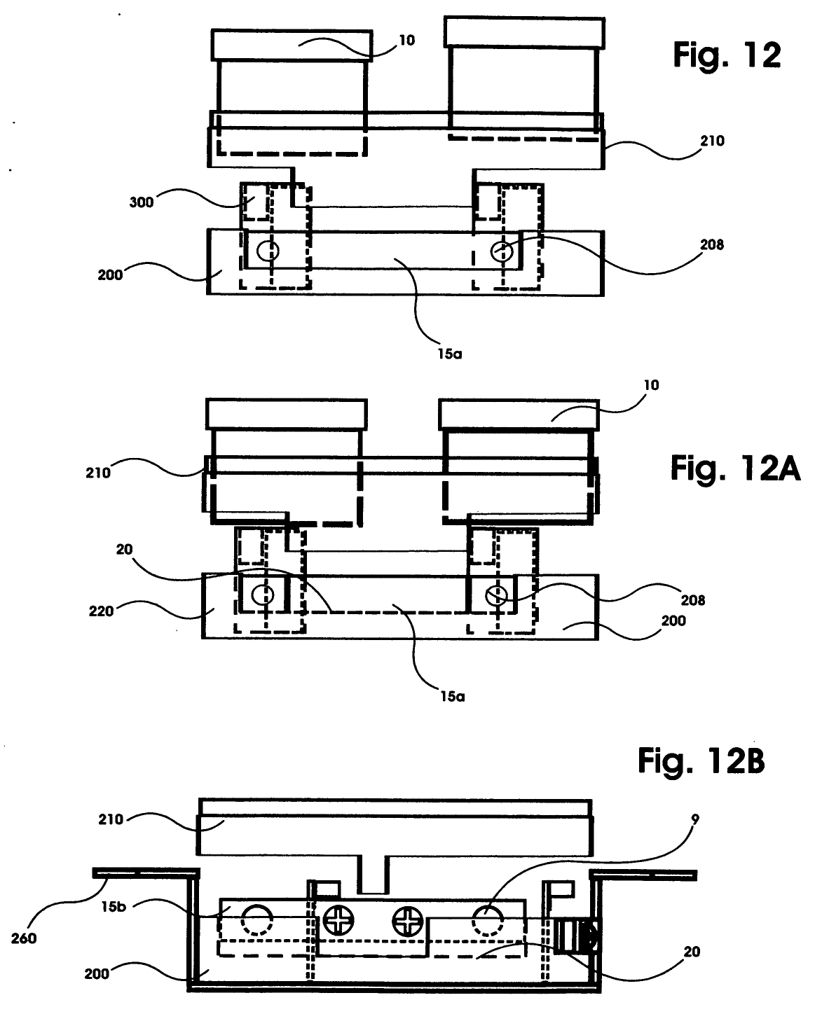

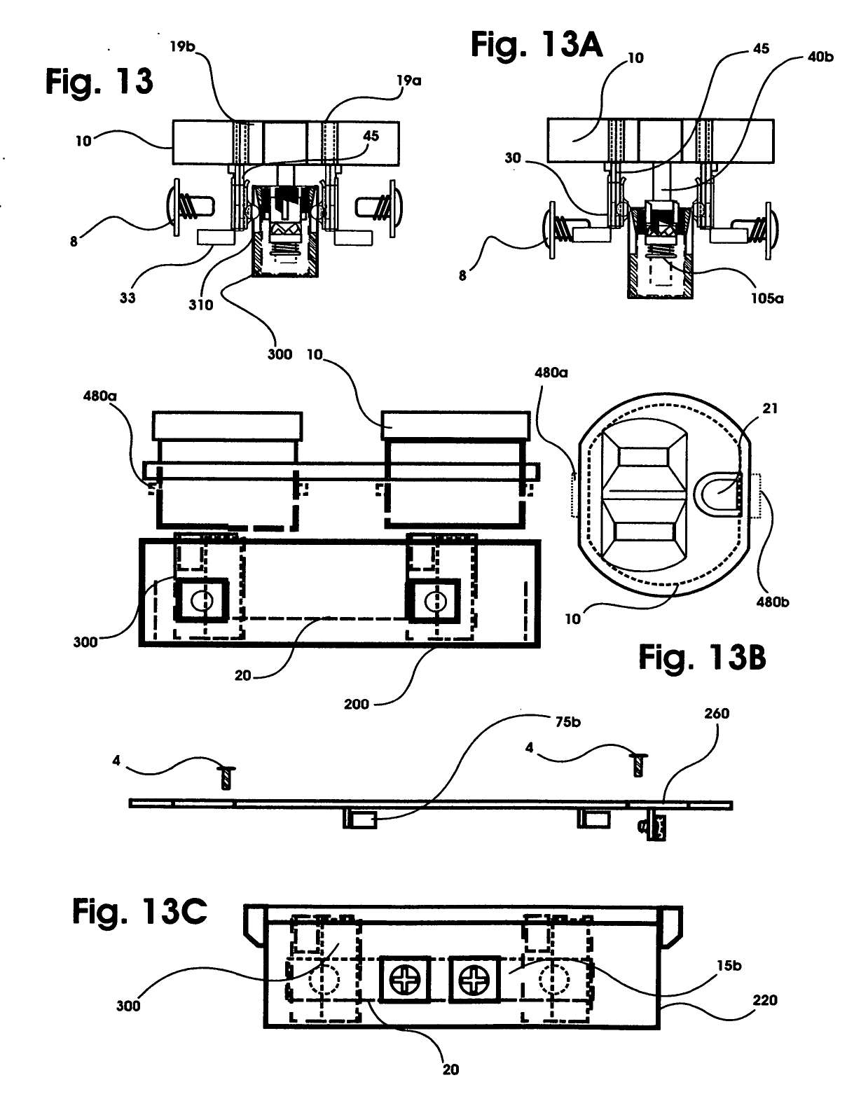

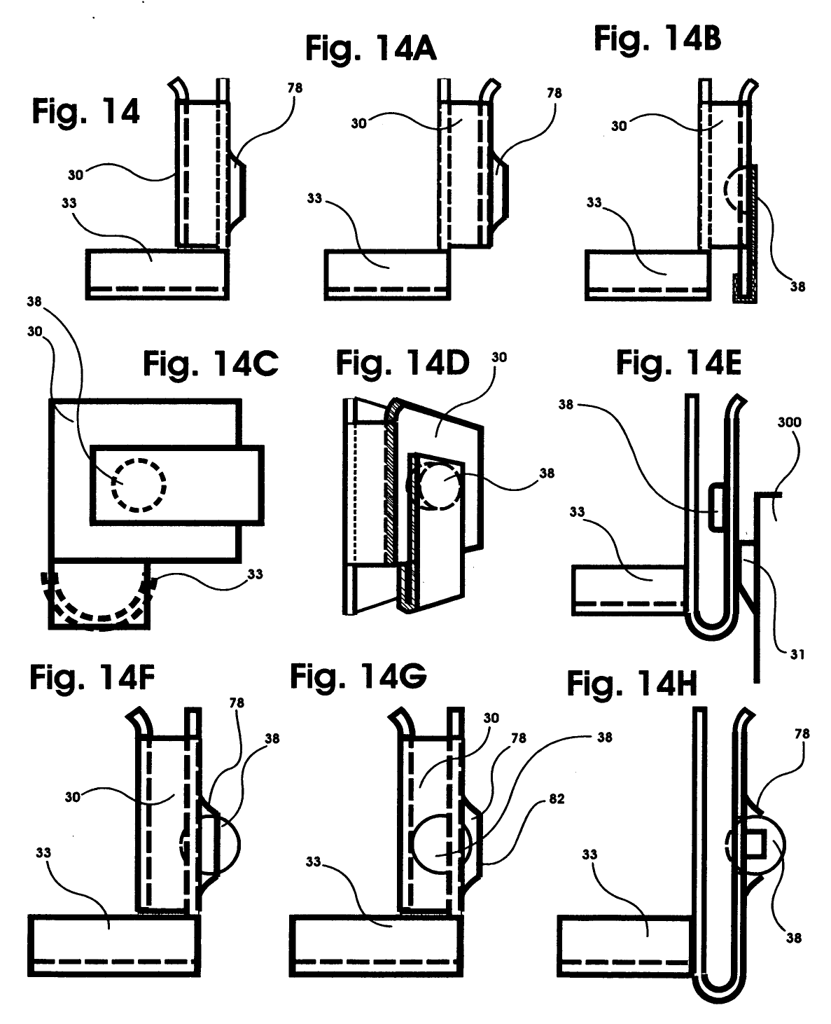

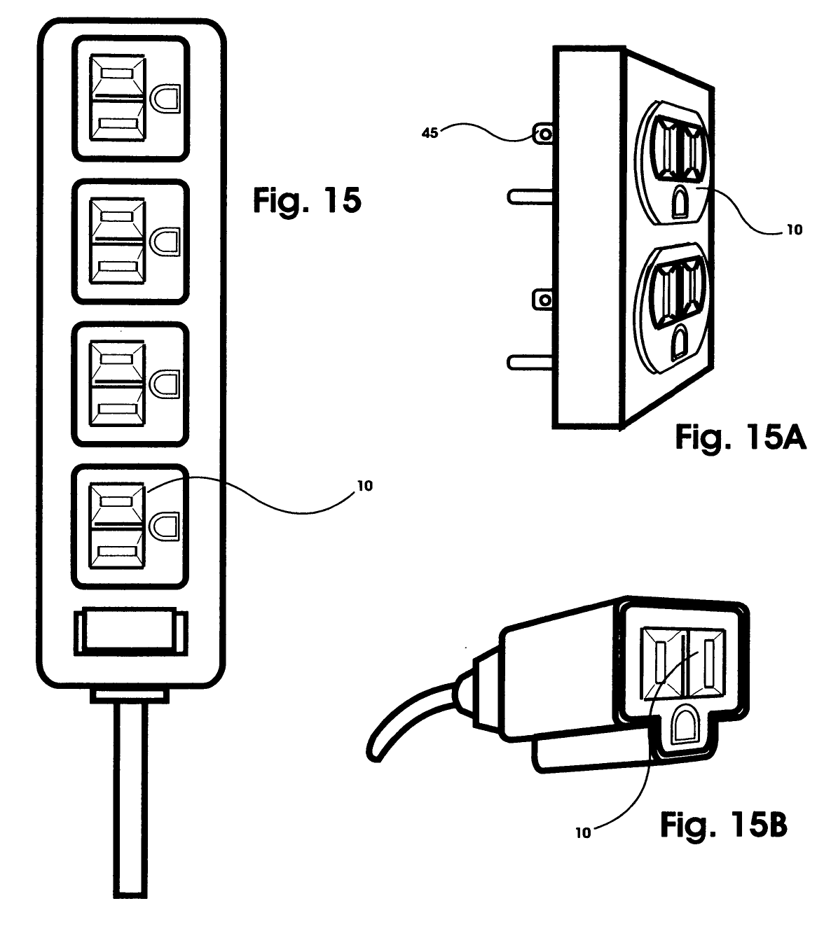

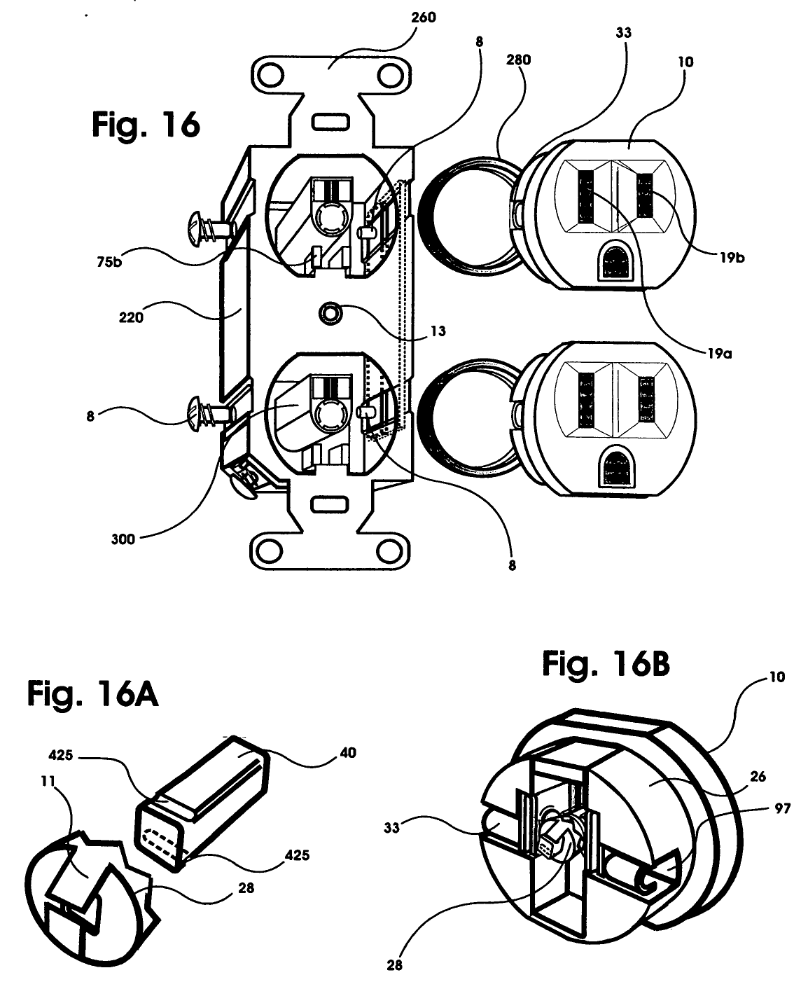

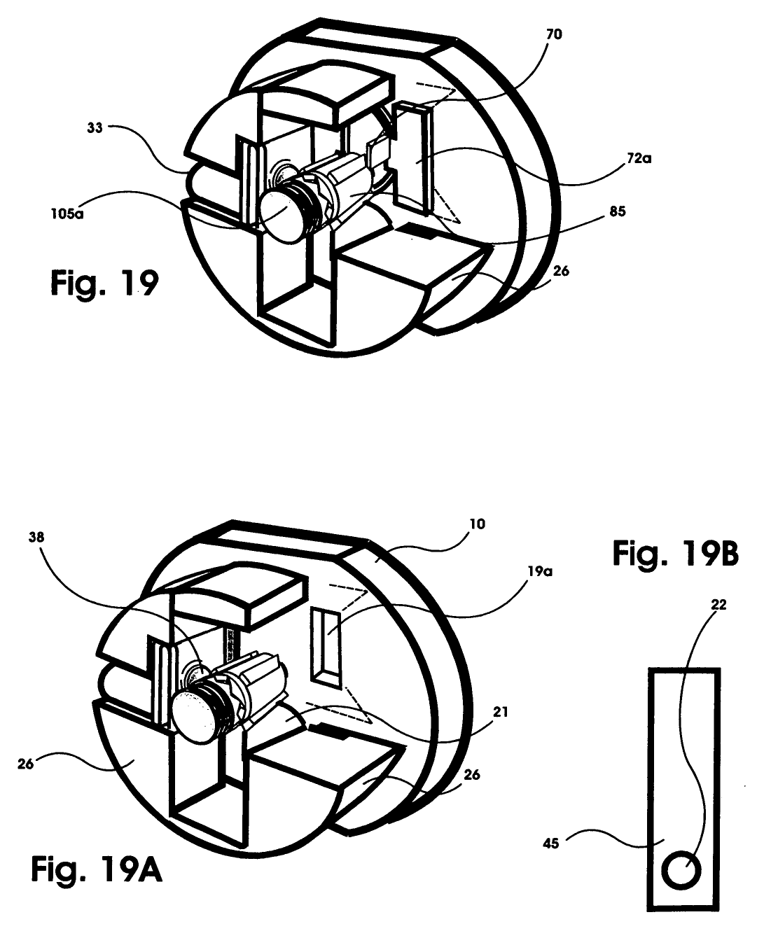

The foregoing in detail is a description of a preferred embodiment of the present invention. Referring to FIG. 1, there is shown in the drawings the body 200 comprised of two parts, the lower body, 200 and the upper body 210. The lower body 200 is fitted with chambers 250 which are adapted to receive receptors 10 when fully assembled. Instruction member 300 also seen in FIG. 1, is formed in conjunction with the body 200 extending somewhat perpendicular from the base of chamber 250 to a predefined distance. Member 300 also fabricated of an insulative material can be seen better in FIG. 2b and FIG. 3. Instruction member 300 is provided with shaft 95 which is adapted to receive positioning member 85 as seen in FIG. 1a. Shaft 95 is also comprised of channels 93 which are designed to receive alignment rails 80 of positioning member 85 respectively as seen in FIG. 1a, and FIG. 2b. Shaft 95 further comprises selection members 88a and 88b which assist in instructing receptors 10 to various positions as seen in FIG. 3a. This will be discussed later in further detail. The body 200 is further provided with recesses 20 which can be seen better in FIG. 12a, and FIG. 12b. Recesses 20 are adapted to receive conductors 15a which would be constructed of a proper material for conducting electrical current. Recesses 20 are accessible, in this configuration to conductive members 15a from front of body 200 as seen in FIG. 1. Contact screws 8 of the conductive members 15a are fitted within and extending into a portion of chamber 250 as seen in FIG. 1, Contact screws 8 would also be constructed with a proper material to allow adequate conductivity of electrical current. Grounding strap 260 is fastened with conventional means around the back of body 200 with grounding contacts 75a extending through the base of body 200 to a predetermined distance within chambers 250, Grounding strap 260 would of course be fabricated of a suitable material for the means of grounding. Grounding contacts 75a are adapted to align within receptors 10 there awaiting probable contact by an inserted grounding pin from a male connector, when applicable. Selection members 88a and 88b found within shaft 95 as seen in FIG. 1, are formed in conjunction with body 200 and instruction member 300. FIG. 1, further reveals spring 280 which is adapted to operate within the confines of chamber 250 there to bias the installed receptor 10. Receptors 10 are fitted with the typical openings 19a and 19b designed to receive the power blades 45 of a conventional electrical male connector and opening 21 to receive the typical ground pin where applicable. Aperture 13 on the boss of upper body 210 is for the attachment of a conventional face plate (not shown). Screw 18, a typical grounding screw, is attached to ground strap 260 as seen on most conventional receptacles. Referring to FIG. 1a, positioning member 85 is comprised of alignment rails 80 and irregular edges 101 both of which are formed as integral part of positioning member 85. Positioning member 85 is designed to operate within shaft 95 of instruction member 300 with alignment rails 80 adapted to alternately ride within channels 93 and shaft 95. In FIG. 1a, restraint 105a which would assist in containing spring 44 in a movable state against biasing member 28 onto shaft 40. Not seen in FIG. 1a biasing member 28 is attached in such a manner as to allow vertical movement only. Also, in FIG. 1b, receptor 10 can be seen in dimensional view exposing hidden parts, contacts 30 and conductive contacting members 33. Also visible is positioning member 85 which is disposed within body 26 of receptor 10. Body 26 of the receptor 10 is adapted to move within chamber 250 when receptacle is fully assembled. Also seen in FIG. 1b, located on contact 30 is blade securing member 38. FIG. 2, shows an enlargement of positioning member 85, revealing alignment rails 80 and angular face 81 which contacts the face 5a of selection member 88a as shown in FIG. 3. Alignment rails 80 further contact 88a and 88b and channels 93 in progression during typical use. In FIG. 2b, spring 44 urges biasing member 28 which has been provided with irregular edges 101 displaying a misalignment to the irregular edges 98 on positioning member 85 revealing it's forth coming instruction as positioning member 85 travels forward within shaft 95 with alignment rail 80 clearing angular face 5b of selection member 88b thereby causing irregular edges 98 of positioning member 85 to move in alignment with irregular edges 101 of biasing member 28, this can be seen in FIG. 2, resulting in misalignment with edges 5b of selection member 88b thereby forcing angular edge 81 of alignment rail 80 to movably follow the predefined angle of edge 5b of selection member 88b resulting in it's placement within channel 93 (as seen in FIG. 13a) thereby misaligning irregular edges 98 of positioning member 85 and irregular edges 101 of biasing member 28 which of course has set positioning member 85 to further this action when travel of angular edge 81 of alignment rail 80 exceeds the face of angular edge 5a of selection member 88a. This result would continue to repeat itself with each successive initiation. Also shown in FIG. 2b, is securing assist member 310 which will be discussed later. In FIG. 3, instruction member 300 is shown in dimension with slope 400 located adjacent the upper surface edge of 88a and 88b. Although slope 400 is not necessary it can aid in the installation of positioning member 85 because of alignment rail 80's inherent misalignment with channels 93. Also in FIG. 3, slope 420 is shown which will be discussed later in more detail. FIG. 2c, shows radius shoulder 415 of alignment rail 80 which could also assist in the installation of instruction member 85 by means of contacting slope 400 which would instruct shoulder 415 to travel directionally as indicated by slope 400 thereby placing alignment rails 80 within channels 93. Angular face 420 as shown in FIG. 3a, terminates at slot 430, which purpose will be discussed later. It must be noted that some of the above attention to manufacturing and assembly detail such as slope 400 and/or radius shoulder 415 are not imperative for the working and operation of the present invention. Furthermore referring to FIG. 5b, radius shoulder 415 is seen on both ends of alignment rail 80 one of which would take the place of angular edge 81. Once again revealing that certain changes may be made to accomplish the same result. Other such additions and details will be found throughout the body of the description and drawings and are not to be misunderstood as vital attributes. FIG. 4, 4a, 4b, reveals varying shapes of receptor 10. In FIG. 4, 10a is somewhat quadrilateral with radios corners. FIG. 4a, shows 10b mostly circular in design with a flat on two opposing sides, resembling receptor 10 face and in FIG. 4b, 10c which is circular in form. As seen in these, 10a, 10b and 10c, The actual shape of body 26 of receptors 10a, 10b and 10c is not imperative for the embodiment to work properly as long as the body 26 itself of receptor 10 is somewhat symmetrical and agrees with chamber 250. Clearly seen with all three are contacts 30 and conductive contacts 33. Also shown in FIG. 4b, within receptor body 26 is ground contact 75c which is slightly modified in form utilizing ground strap 260 installed on front of receptacle by conventional means, possibly a set screw or the like, taking the place of upper body member 210. FIG. 5, shows positioning member 85 in a perspective breakdown revealing the positions of related parts. Shaft 40b could be formed as integral part of receptor 10 or if manufacturing and or assembly might dictate can be a separate item. The body of positioning member 85 is movably installed on shaft 40b allowing lateral movement, lateral movement only is preferred but not imperative. Also in FIG. 5 key 39 is there to respectively guide biasing member 28 onto shaft 40a through the corresponding opening 235 on the base of biasing member 28. Spring 44 installs behind biasing member 28 keeping biasing member 28 juxtaposed positioning member 85 with restraint 105a as base for spring 44. Also seen in FIG. 5, is restraint 105b respectfully adjacent the rear surface of positioning member 85 so as to not allow rearward movement. Restraint members 105a and 105b as with others can be fashioned in many forms as manufacturing might dictate assuming the result would be the same or similar. In FIG. 5b, biasing member 28 is shown with a slight modification to incorporate spring 44 by utilizing bendable flaps 11 which upon installation rest within notches 425, as best seen in FIG. 16, In FIG. 5, irregular edges 98 of positioning member 85 and irregular edges 101 of biasing member 28 are clearly visible and will be explained later in further detail. Also in FIG. 5c, a slightly modified shaft 40a showing a square tube section in conjunction with a typical circular tube. The circular design would allow positioning member 85 to move laterally when needed and to be adjusted by biasing member 28. The square or rectangular section would work to place biasing member 28 to a stable position with shaft 40a penetrating the somewhat rectangular opening 235 in the base of biasing member 28, thereby only allowing vertical movement toward and away from positioning member 85. It should be noted that these movements, shapes, and order of installation could be changed to accomplish the same or similar result. In FIG. 5c, biasing member 28 incorporates no member to hold it onto shaft 40a but relies only on spring 44 resting at the base of shaft 95 urging it's under face to keep biasing member 28 respectfully onto shaft 40a. Referring to FIG. 6b, reveals a mostly assembled receptacle body 200 (without upper body 210) with body 26 of receptor 10 visible. The main focus of FIGS. 6b, 7b, and 8b are to show a travel progression of blocking member 500, which is comprised of extension arms 70 and covers 72a and 72b with integral elastic convergence arms 270. FIG. 6, exposes the progression of receptor 10 and extension arms 70 of blocking member 500 and securing member 38 during travel within chamber 250 of receptacle body 200 as relative to any nonmoving part and also in relation to contact screws 8. At this point it must be mentioned that when the receptor 10 is activated by pushing in slightly without blade 45 insertion, that upon release as receptor 10 is in the process of arriving at it's predetermined destination, the end angle of extension arms 70 are adapted to come forth out of slots 430 while moving with receptor 10 there to ride up the surface of slope 420. Since blocking member 500's natural position is with extension arms 70 opposite each other to the maximum distance, which is accomplished by the inherent resiliency that would be provided by a material such as polycarbonate. In like manner upon opposite action, slope 420 acts to urge extension arms 70 to move together simultaneously moving covers 72a and 72b away from power bade slots 19a and 19b, resulting in extension arms 70 returning positionally within slots 430 as seen in FIG. 6a, In FIGS. 6, and 6a, this position is achieved when positioning member 85 is placed as seen in FIG. 2b, In FIG. 6a, blocking member 500 is held in check as a result of extension arms 70 residing in slots 430. FIGS. 7, 7a, and 7b, 8, 8a, and 8b, also show additional progression of covers 72a and 72b of blocking member 500 during normal activity. Blocking member 500 would be fabricated of a suitable insulative resilient non conducting material such as polycarbonate or the like allowing blocking member 500 to function as intended. Referring to FIG. 9, blocking member 500 is shown in it's natural state with covers 72a and 72b opposing each other as when fully initiated without male blade insertion. At this point covers 72a and 72b of blocking members 500 will be found covering the conventional slots 19a and 19b of receptor 10 as seen in FIG. 8b, and FIG. 19. It must be mentioned at this point that when power blades 45 of a conventional male connector are fully inserted that covers 72a and 72b of blocking member 500 would be in the same position as covers 72a and 72b in FIG. 6a, binding against the flat of power blades 45, even though the travel and position of receptor 10 would be the same as seen in FIG. 7a. In FIG. 6, is shown receptor 10 in a static form awaiting initiation in relation to the other components. Also revealed is the lack of contact between contact screws 8 and the conducting contacts 33 of the contacts 30. The following will be better understood when referred to FIG. 2b, and FIGS. 13, and 13a, during the following description. As receptor 10 would be inserted slightly into chamber 250 extension arms 70 of blocking member 500 would stop at the terminal end of slots 430 with securing member 38 resting at the bottom of securment assist member 310, thereby allowing a full insertion of power blade 45 of a typical male connector. Also at this point alignment rails 80 of positioning member 85 would have traveled forward as well clearing angular face 5a the further end of selection member 88a simultaneously irregular edges 98 of positioning member 85 and irregular edges 101 of biasing member 28 would align thereby aligning angular flat 81 of alignment rail 80 with angular face 5b of selection member 88b. Upon release of the male connector, receptor 10 would be instructed outward away from the base of chamber 250 by spring 280, which would bring angular face 81 of alignment rail 80 to contact angular face 5b of selection member 88b causing instruction member 85 to follow the angular direction in lateral manner resulting from contact with angular face 5b and angular flat 81 and the constant pressure from spring 280, simultaneously positioning member 85 would turn slightly on it's axis causing alignment rail 80 to slide within channel 93 thereby misaligning irregular edges 98 of instruction member 85 and irregular edges 101 of biasing member 28. During this same action extension arms 70 of blocking member 500 would also move vertically outward away from the bottom of slots 430 resulting with covers 72a and 72b binding against power blades 45 of the inserted male connector. It must be mentioned at this point that if the male connector were jerked out of the receptacle, the blocking covers 72a and 72b of blocking member 500 would under a natural resiliency immediately move over slots 19a and 19b where the blades 45 of the male connector were previously inserted. Simultaneously during the aforementioned travel securing member 38 would travel up within securing assist member 310 forcing securing member 38 toward aperture 22 of the inserted blade 45 of the male connector eventually resting somewhat partially within aperture 22 securing blade 45 of the male connector to a desired strength. As a general note Underwriters Laboratory, known as U.L. has set forth definitions and specifications as to the amount of pull strength that it would take to remove a male connector from various receptacles. That being said the present invention has taken this into consideration being that the design would make room for and can meet any and all pull strength specifications. Also along with this action conducting contacts 33 of contacts 30 engage contact screws 8 thereby allowing the access of electricity to the inserted electrical male connector as seen in FIG. 8. Referring to FIG. 14c, securing member 38 is contiguous with contact 30 and is held in check at this position with containment lip 31 which this rendition located on the sides of instruction member 300 in place of securing assist member 310. Also seen in FIG. 14c, The closeness of securing member 38 itself to lip 31 an depending on the specifications of contact 30 would secure blade 45 within contact 30 to any desired strength. Referring to FIGS. 10c, 10b, 10a, and 10, there is shown a dimensional View. FIG. 10c, shows the inside of lower body 200, conducting member 15a, contact screw 8 grounding contact 75a instruction member 300 with it's components, and grounding strap 260. FIG. 10b, shows upper body 210 with phantom lines revealing grounding contact 75a and body 26 of receptor 10, FIG. 10a, shows upper body 210 with access openings 135 and attachment aperture 13. FIG. 10, shows the typical frontal face view of receptor 10. FIGS. 11, 11a, 11b, 11c, also revealing the aforementioned components with conductive member 15a slightly modified to 15b which includes conductive pins 9 separate of contact screws 8, better seen in FIG. 11a. Also available in FIG. 11b is grounding strap 260, which of course could take on many shapes in relation to manufacturing. In FIG. 11a, is shown that upper body 210 has circular openings 135 that would of course receive a more circular receptor 10, which can be seen as 10b in FIG. 4a. Again FIG. 11, revealing the frontal view of a typical set of receptors 10. Referring to FIGS. 12, 12a, and 12b, there is shown a slight variation of lower body 200 and upper body 210, FIG. 11a, utilizing the slightly modified conductive member 15b with FIGS. 12, and 12b, utilizing conductive member 15a. Referring to FIG. 13c, reveals lower body 200 and upper body 210 as one unit 220, it must be mentioned here that separation of the body into two parts or as one piece would have manufacturing implications only and would in either situation not effect the operation of the invention. Also in FIG. 13b, grounding strap 260 has a slightly modified grounding contact 75b, knurled set screws 4 for attachment to body 220. Grounding contacts 75b would be accessible to the ground pin of an electrical male connector when inserted through the typical slot 21 in the face of receptor 10. Referring to FIG. 13b, there is shown on the sides of receptor body 10 check members 480a and 480b which are not necessary. However they could be used to serve as further means of holding the receptor 10 securely within receptacle body 200 and 210 collectively or body 220. Up to now receptor 10 has been held in check by means of contact screws 8 which should prove to be adequate for this task as seen in FIG. 13b. Also in FIG. 13b, the face of receptor 10 with check members 480a and 480b can be seen more readily. Referring now to FIG. 13, is shown an inactive or uninitiated receptor 10 revealing that there is no contact between conductive screws 8 and conductive contacts 33 of contacts 30. Also in FIG. 13, is shown power blades 45 of a male connector fully inserted through slots 19a and 19b with securing member 38 passive to power blade 45. FIG. 13a, reveals receptor 10 in an initiated state allowing electrical current accessible to the inserted power blades 45. Also seen here securing member 38 is partially residing within aperture 22 of power blade 45 thereby securing power blade(s) 45 into contacts 30. In addition contact screws 8 are resting in a contacted state with conductive contacts 33 of contacts 30. Also shown in FIG. 13a is the lack of blocking member 500, which is not necessary for the receptacle to work and provide a respectable level of safety in it's switching manor. Also seen in FIGS. 13, and 13b, is alignment shaft 40a. Referring to FIGS. 14,14a,14b,14c,14d,14e,14f,14g, and 14h, there is shown slight variations of contacts 30, in FIG. 1, contact 30 is shown with it's slightly flexible portion facing outward from center of receptor (not shown). In FIG. 14c, the slightly flexible portion of contact 30 is located toward the center axis of receptor 10 (again not show here). FIG. 14b, reveals a slightly modified securing means 38 which could be contiguous with contact 30 as seen in FIGS. 14c,14d,14e or a separately attached member as here. In FIG. 14c, as mentioned earlier securing means 38c is considered an embossed nodule or the like (from an impression or depression) contiguous with contact 30, and slightly modified over contact 30 in FIGS. 1 and 2. To mention at this point that if the slightly modified contact 30 as seen in FIG. 14c with securing means 38c as a nodule or nib, the inserted blade 45 would forcibly pass securing means 38c by outwardly forcing the somewhat flexible portion of contact 30 (because space would permit this), however upon a forced retraction of blade 45 without proper removal (because of a lack of additional space) blade 45 would be restricted by securing means 38c because of an engaged lip 31 located on the sides of instruction member 300. Of course as previously mentioned this could be adjusted to allow a forcible removal of blade 45 at a pre determined pull strength or removed by simply pushing receptor 10 back in slightly which would un engage securing lip 31 therefore providing the space needed for the somewhat flexible portion of contact 30 to move outward, allowing the inserted blade 45 to clear securing means 38c. In FIG. 14g, securing means 38 could be in this position if no power blade 45 were inserted, however if a power blade 45 were to contact securing means 38 at this point, securing means 38 would be forced into depression 78, as is seen in FIGS. 14f, and 14h, because blade 45 would contact securing means 38 off center. Also, after a full insertion of power blade 45 and upon full initiation of receptor 10 securing means 38 would be instructed by securment assisting member 310 to find a respectable position within a portion of aperture 22 located toward the end of power blade 45 as seen in FIG. 19b, thereto assist in holding power blade 45 within contact(s) 30 of receptor 10. This position of securing means 38 would be very close to the position found in FIG. 14g. It must also be mentioned at this juncture that upon a forcible removal of the male power blade 45, since the center of securing means 38 would be contacted by the inside of aperture 22, once again off center, securing means 38 would be forced to take a similar path as before thereby moving back into depression 78 respectively as seen in both FIGS. 8, and 9. Also seen in these FIGS. 14,14c,14f,14g, and 14h, is depression 78 with aperture 82 in the center as seen in FIG. 14e, for functioning with securing member 38. To mention at this point that aperture 82 of depression 78 is sized in such a manner as not to allow securing means 38 to move through, but is of a size who's diameter is sufficiently smaller than the circumference of securing means 38 so as to allow movement within. In FIG. 14f, securing means 38 can be seen in a passive state resting in depression 78, and in FIG. 14g, in an aggressive state. FIG. 14h, shows a slightly modified contact member 30 similar to the one in FIG. 14c. In FIGS. 14,14a,14b,14c,14e,14f,14g, and 9 also show conductive contact members 33, with FIG. 4, showing the shape from an alternate view (Simi radius, which is preferred but not necessary). In FIGS. 15, 15a and 15b, there is shown variety of applications of the present invention utilized as a power strip or serge protector, as in FIG. 15, a retro fit item, to attach to a typical receptacle, as seen in FIG. 15a, and in FIG. 15b, as a typical power cord. Also, to mention that these are only a few of related applications, however it would be obvious that the present invention could be employed on a much larger scale some of which would not take on the shape of a receptacle as one might consider.

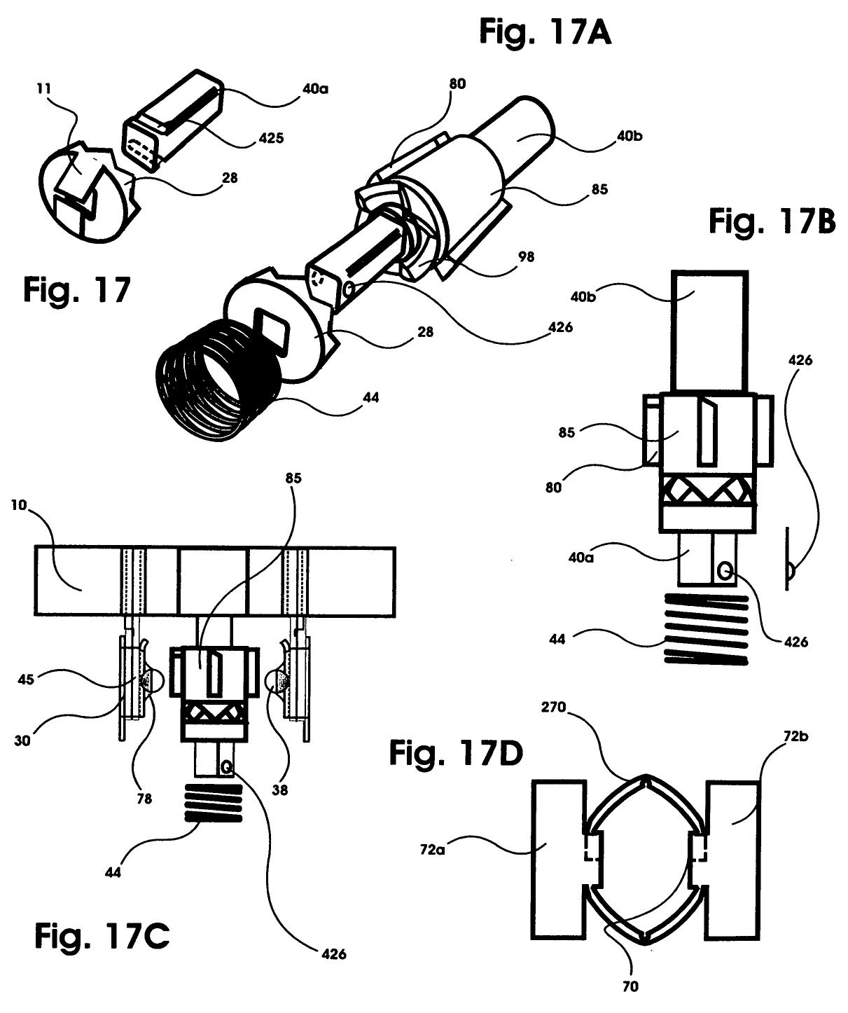

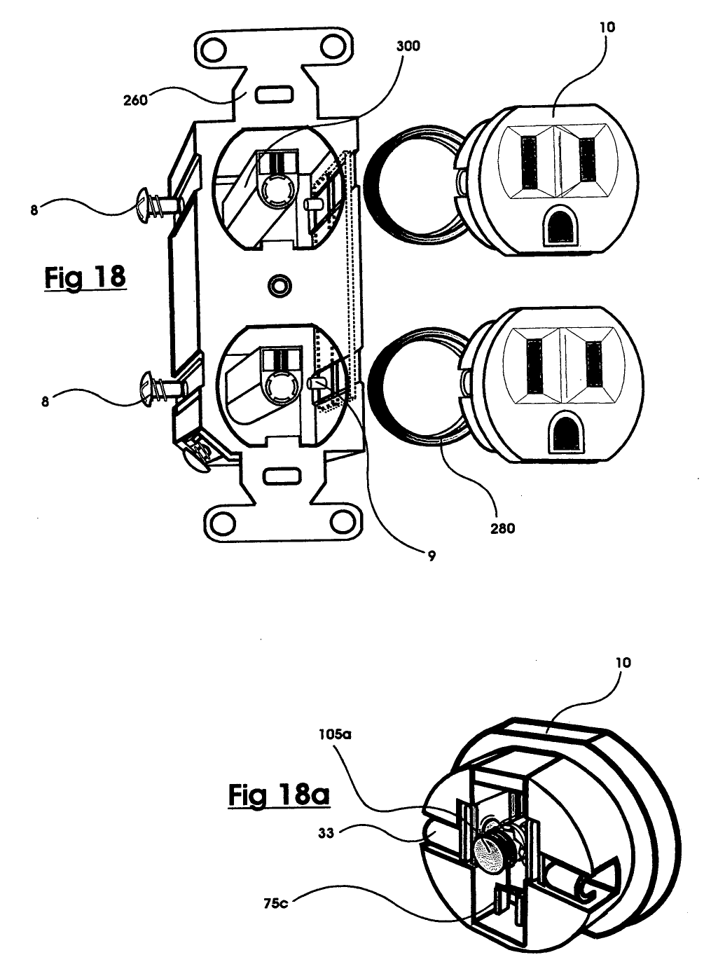

Referring to FIG. 16, there is shown the preferred embodiment with some of the members combined; a one piece body 220 which combines lower body 200 and upper body 210. The one piece body 220 allows installation of conductive member 15a from it's external face the body 220 could be adapted to accept conductive members 15a from the sides instead depending on manufacturing and or assembly preferences. Also, shown is grounding strap 260 placed over the front of body 220 instead of around the back of 200 as best seen in FIGS. 1,6b,7b, and 8b. Also seen in FIG. 16, are contact screws 8 and ground contact 75b which is placed within chamber 250 from the front instead of through the back of lower body 200 as seen in FIGS. 1,10b,11c, and 12b. In FIG. 16a biasing member 28 is shown provided with bendable flaps 11 alleviating the need for spring 44. As mentioned earlier notch's 425 and bendable flaps 11 are employed in order to secure biasing member 28 to shaft 40a. It would be obvious that many different variations could be utilized to accomplish the same. Referring to FIG. 16b slots 97 located on the sides of receptor body 26 of receptor 10 are there for conductive screws 8 to extend within upon complete assembly awaiting alternate contact with conducting contacts 33 thereby restricting movement inward and outward of the installed receptor 10. Referring to FIG. 17d, there is shown blocking member 500 in a dimensional view. In FIG. 17, there is shown a alternate means to hold biasing member 28 to shaft 40a and 40b, notching means 425, as mentioned earlier, and a nodule 426. Notching means 425 could alleviate spring 44 and restraint 105a. The nodule 426 would alleviate restraint 105a and 105b only. FIG. 17a, shows the employment of these variations in relation to receptor 10 and contacts 30. FIG. 17b, shows shaft 40a utilizing nodule 426 from a different perspective. FIG. 18, shows the present invention with a one piece body 220 with grounding strap 260 in front instead of attached to the back of the body 200. The main variation in this view can be seen in FIG. 18a, ground contact 75c is located in body of receptor 10 instead of on grounding strap 260. This is of course not necessary for the present invention to operate as intended. However in some applications, if needed, an additional member fabricated out of what would be considered a more conductive material might be specified. FIG. 19, reveals an exploded fragmentary view of the receptor 10 revealing the position of blocking member 500 when fully engaged without blade 45 insertion or after a blade 45 were jerked out of place without proper operation. In this case blocking member 500 would be over the blade slots 19a and 19b as pre defined on a typical receptacle. FIG. 19, also further shows the placement of positioning member 85 and it's components as relative to receptor 10. Also present in FIG. 19, is the typical ground pin slot 21 utilized by the ground pin of a typical electrical male conductor. FIG. 19a, reveals receptor 10 not utilizing blocking member 500. Which is of course, as mentioned earlier, not necessary for the present invention to work and provide a respectable level of safety.

It is set forth and understood that some appliances, tools, machinery and other electrically operated devices will require varying plug prong accepting configurations and or voltage and, or amperage requirements per each application. All of these alterations are within the guidelines and the scope of the invention and its intention. The aforementioned description is not meant to be exhaustive nor to limit the present invention to the precise form disclosed. It would be obvious to one skilled in the art that certain changes and modifications, the combining of operation of some or all of the parts, changing of geometrical shapes with intent for accomplishing similar actions, modification of descriptions, all of which could be accomplished and still remain in the scope and the spirit of the present invention.

What is claimed:

1. A female electric receptacle for receiving a male electric power plug having conductive terminals, said female receptacle comprising:
a receptacle body having at least one substantially uniform chamber, said chamber having a bottom,
a positioning system disposed within said chamber, said system being fixed to the bottom of said chamber and having a recessed upper portion,
a first conductive connector mounted on said receptacle body to engage the powered conductor of a conductor pair,
a second conductive connector mounted on said receptacle body, said second conductor engaging the neutral conductor a conductor pair,
a first contact member connected to said first conductive connector and disposed inside said chamber,
a second tubular contact member adjacent to said second conductive connector, said second member being disposed inside said chamber spaced apart from said first member,
a uniform plug receptor adapted to fit within said chamber to receive the terminals of said male electric plug, said receptor having area to receive said locking system, said receptor being positioned about said system and adapted to move axially between detent positions and to move up and down within limits within said chamber,
a first conductive contact disposed on said receptor and adapted to make electrical contact with said first contact member when said receptor is moved in said chamber,
a second conductive contact disposed on said receptor and adapted to make electrical contact with said second contact member when said receptor is move upon said member within said chamber,
a spring disposed between the bottom of the chamber and the bottom of the plug receptor, whereby the receptor is biased upward when the plug receptor is moved to said detent position, and
a pair of movable conductive contacts disposed within said plug receptor, said contacts being disposed adjacent to said connectors of said male electrical plug, said movable contacts being in mechanical contact with the embossed portion of the locking system, whereby said member grippingly engages said connectors when said plug receptor is moved up and electrical power flows from the female receptacle to the male plug.

2. A female electric power receptacle as in claim 1 wherein the detent position of the plug receptor is determined by a groove in said positioning system that engages a inwardly projecting member fixed to the inside surface of the receptor.

3. A female electric receptacle as in claim 2 wherein the pair of moveable conductive contacts includes at least one nonconductive locking member that engages the connector of the male electric power plug.

4. A female electric receptacle as in claim 1 wherein the moveable contacts are nonconducting and the plug receptor has a pair of conductive members disposed so as to contact the contacts of the male electric power plug when the plug receptor moves upward in the chamber at the detent position.

5. A female electric receptacle as in claim 1 wherein a pair of moveable blocking members move laterally of the receptor to cover the blade slots when initiated without electric plug.

6. A female electric receptacle as in claim 1 wherein the pair of moveable blocking members are biased the power blades of the electrical plug.

7. An electrical receptacle comprising;
1) a receptacle body having a cavity;
2) a plug receptor adapted to be received in said cavity in said receptacle body, said plug receptor to moveably communicate within said cavity and adapted to move inward and outward, said plug receptor having an electrically conductive portion electrically engageable with an electrical plug;
3) a spring disposed between said plug receptor and said receptacle body and applying an outward force to said plug receptor away from said receptacle body; and
4) a contact member coupled to and protruding from said receptacle body for electrically contacting said electrically conductive portion of said plug receptor;
wherein, when a user applies a forward force against said plug receptor and moves said plug receptor inward to a predetermined amount of said receptacle body, and releases the inward applied force, resulting in the plug receptor moving axially outward away from said receptacle body, the contact member and the electrically conductive portion engage to form an electrical connection between the plug receptor and the receptacle body.

8. The electrical receptacle of claim 7, wherein
a portion of said electrically conductive portion is disposed in a channel in said plug receptor and said contact member is a tubular conductor that engages with said electrically conductive portion in the channel.

9. The electrical receptacle of claim 7, wherein
engagement of said contact member and said electrically conductive portion results in locking of said electrical plug.

10. The electrical receptacle of claim 8, wherein
a portion of the electrically conductive portion is disposed at a first end of said channel.

11. The electrical receptacle of claim 7, and further comprising;
a nib that locks the electrical plug and prevents axial removal of the electrical plug from said plug receptor.

12. The electrical receptacle of claim 11, wherein
the nib is a sphere and locks the electrical plug after movement of said plug receptor.

13. The electrical receptacle of claim 11, wherein
a protrusion on said nib engages a hole in the electrical plug.

14. The electrical receptacle of claim 12, wherein
a protrusion on the nib engaged a detent on the electrical plug.

15. The electrical receptacle of claim 7, wherein
a ramping mechanism positions said sphere into a locking position during relocation of said plug receptor.

16. The electrical receptacle of claim 7, wherein
a blocking member moves in unison with the plug receptor to bias the inserted blades of the electrical plug.

17. The electrical receptacle of claim 16, wherein
a blocking member covers the blade entry slots of the receptor.

18. An electrical receptacle, comprising;
a receptacle body having a cavity;
a spring-loaded plug receptor adapted to be received in said cavity in said receptacle body, said plug receptor having a central axis and adapted to move axially along said central axis in said cavity, said plug receptor having an electrically conductive portion electrically engageable with an electrical plug, said plug receptor further comprising an electrical plug locking mechanism for locking the electrical plug within the plug receptor; and
a contact member coupled to and protruding from said receptacle body for electrically contacting said electrically conductive portion of said plug receptor;
wherein, when a user inserts the electrical plug into said spring-loaded plug receptor and applies an axial force against said spring-loaded plug receptor and moves said spring-loaded plug receptor axially of said receptacle body, then releases said plug receptor to move axially to a predetermined amount, and the electrical plug is locked into the plug receptor; and
wherein, when the axial force is released, said plug receptor moves axially outward away from said receptacle body, the contact member and the electrically conductive portion engage to form an electrical connection between the plug receptor and the receptacle body.

19. The electrical receptacle of claim 18, wherein
said electrical plug locking mechanism comprises a nib that locks said electrical plug and prevents axial removal of said electrical plug from said plug receptor.

20. The electrical receptacle of claim 19, wherein
said nib locks said electrical plug after axial movement of said plug receptor.

21. The electrical receptacle of claim 19, wherein
a protrusion on said nib engages a detent in said electrical plug.

22. The electrical receptacle of claim 19, wherein
a protrusion on said nib engages a hole in said electrical plug.

23. The electrical receptacle of claim 19, wherein
a ramping mechanism moves the nib into a locking position during axial movement of said plug receptor.
